(19) United States
(12) Patent Application Publication
(10) Pub. No.: US 2021/0316322 A1
(43) Pub. Date: Oct. 14, 2021

(54) Shower Head Assembly

(71) Applicant: YO CA CASTERS CO., LTD., Taichung (TW)

(72) Inventor: Chin-Lin CHANG, Taichung (TW)

(21) Appl. No.: 17/244,303

(22) Filed: Apr. 29, 2021

Related U.S. Application Data
(63) Continuation-in-part of application No. 16/433,815, filed on Jun. 6, 2019.

(51) Int. Cl. B05B 1/18; A46B 11/06

(52) U.S. Cl. CPC B05B 1/18; A46B 2200/1006; A46B 11/063

(57) ABSTRACT

A shower head assembly contains: a body, a cover, and a movable massage set. The body includes a shower head and a handle, the handle having an inlet segment, a conduit, a water supply face, and an external fence. The water supply face has multiple spray nozzles and receiving orifices. The external fence has a slide face, a first coupling portion, and two second coupling portions. The cover includes a head portion and a gripping portion. The head portion has a connection face, and the gripping portion has a fixing protrusion. The connection face has a first retainer, and the cover has two second retainers. The movable massage set includes a flexible portion which has a connection element and multiple defining extensions. The movable massage set also includes a control unit which has an actuation projection and two sliding bosses. The flexible portion has a first abutting section and a second abutting section.

### FIELD OF THE INVENTION

The present invention relates to a shower head assembly which accommodates a movable massage set conveniently and safely.

### BACKGROUND OF THE INVENTION

A conventional shower head assembly contains a message set extending therefrom, but the message set is broken easily when the conventional shower head assembly drops on a floor.

A conventional compact portable pocket brush is disclosed in U.S. Pat. No. 4,137,596 and has retractable bristles arrayed in groups attached to a plurality of bristle group holders or supports mounted upon pivot pins in a brush case. The top wall of the case has a plurality of downwardly sloping apertures respectively located in alignment with each bristle group in the brush. The bristle group pivot pins are pivotably mounted upon a slide in the bottom of the case. When the slide is moved between two positions, each bristle group is pivoted between a retracted position in which it is enclosed within the case and an erect position wherein the bristles extend through the openings in the top wall of the case. When in the erect position all of the bristle groups are locked in a rigid vertical position by the engagement between the periphery of the holes and a portion of the bristle group holder so that the brushes can be used. However, the compact portable pocket brush cannot be used to massage a user.

A conventional retractable brush is disclosed in U.S. Pat. No. 4,977,909 and includes a hollow casing combined by a lower cover drilled with a bristles holes therein and an upper cover, a bristle base slidably held in the casing having a plurality of bristles formed on the base extendible outwardly from the lower cover for combining and brushing use, and a bristle extender having a push button slidably held in the upper cover which is depressed to push the brittle base downwardly in order to extend the bristles outwardly until being locked on the upper cover and upon a disengagement of the push button from the upper cover, the bristles will be retracted into the casing as restored by a restoring spring. Upon the extending of the bristles for combing or brushing operation, a water stream may also be applied through the hollow casing, the bristles holes to spray onto the hairs as being combed or brushed. But the conventional retractable brush cannot be applied to massage a user and has a complicated structure.

A conventional hair comb is disclosed in U.S. Pat. No. 7,134,439 and includes a succession of teeth having at least one tooth that bears a hook, and at least two teeth without hooks. The hook may extend at least in part beyond a plane that is defined by at least two teeth in the succession. Nevertheless, the conventional hair comb cannot be used as a shower head and does not include a movable massage set. In addition, a structure of the conventional hair comb is complicated.

A conventional shower head is disclosed in U.S. Pat. No. 9,615,701 and includes a main body, a motor, a cleaning device and a liquid dispenser. The main body has a channel, an inlet and a plurality of outlets. The channel fluidly connects the inlet and the plurality of outlets. The motor is disposed in the main body and has a driving shaft. The cleaning device is connected to the shaft of the motor. The cleaning device has a cleaning portion exposed on the main body. The liquid dispenser is disposed in the main body and has an outlet terminal in fluid connection with the cleaning portion. However, the conventional shower head does not include a movable massage set. Furthermore, a structure of the conventional shower head is complicated.

The present invention has arisen to mitigate and/or obviate the afore-described disadvantages.

### SUMMARY OF THE INVENTION

The primary objective of the present invention is to provide a shower head assembly which accommodates a movable massage set conveniently and safely.

To obtain above-mentioned objective, a shower head assembly provided by the present invention contains: a body, a cover, and a movable massage set.

The body includes a shower head and a handle, the handle has an inlet segment formed on a free end of the handle, a conduit defined in the shower head opposite to the inlet segment, an water supply face formed on an front face of the shower head, and an external fence formed on a back face of the shower head. The water supply face has multiple spray nozzles arranged thereon and communicating with the conduit, and multiple receiving orifices defined on multiple predetermined positions of the water supply face and communicating with the external fence. The external fence has a slide face, a first coupling portion formed on a top of the external fence, two opposite second coupling portions formed on two predetermined positions of the external fence, and the handle has a positioning portion formed thereon opposite to the external fence.

The cover includes a head portion and a gripping portion. The head portion has a connection face, and the gripping portion has a fixing protrusion extending from a bottom thereof and corresponding to the positioning portion of the body so that the fixing protrusion is engaged with the positioning portion. The connection face has a first retainer corresponding to the first coupling portion of the body, and the cover has two second retainers corresponding to the two opposite second coupling portions of the body, such that the first retainer is engaged with the first coupling portion, the two second retainers are engaged with the two opposite second coupling portions of the body, and a slidable channel is defined between the cover and the slide face of the external fence of the body. Each of the conduit and the slidable channel are an independent space, the gripping portion has a control zone defined on a predetermined position thereof, and the control zone has a slot, two moving sections defined on two side walls of the slot, and four recesses formed on two ends of the two moving sections.

The movable massage set is received in the slidable channel between the body and the cover, the movable massage set includes a flexible portion made of flexible material and is elongated, the flexible portion has a connection element formed on an first end of the flexible portion, multiple defining extensions extending from the connection element and movably extending out of or retracting into the multiple receiving orifices of the body, and the connection element is fixed with the external fence. The flexible portion has a first abutting section formed on a predetermined position of a first face thereof, a second abutting section formed on a predetermined position of a second face of the flexible portion, such that the second abutting section and the first abutting section slidably contact with the slide face of the body and the connection face of the cover so as to reduce a friction coefficient of a movement of the flexible portion. The movable massage set further includes a control unit arranged on a second end thereof and corresponding to the control zone of the cover, and the control unit has an actuation projection and two sliding bosses located on two sides of the actuation projection, such that the actuation projection is moved back and forth in the slot of the cover, the movable massage set are moved to extend out of or retract into the multiple receiving orifices of the body, and the two sliding bosses are slid on the two moving sections of the cover and are limited in the four recesses.

Accordingly, the actuation projection of the movable massage set is moved to drive the multiple defining extensions to extend out of or retract into the multiple receiving orifices of the water supply face of the body. After the multiple defining extensions extend out of the multiple receiving orifices of the water supply face of the body, the multiple defining extensions massage a user's body. After the multiple defining extensions retract into the multiple receiving orifices, the multiple defining extensions are not broken when dropping the shower head on a ground. Furthermore, the movable massage set of the body is slid in the slidable channel and does not interfere a water supply in the conduit, thus flowing water inside the shower head assembly smoothly. Preferably, the shower head assembly contains the body, the movable massage set, and the cover merely to simplify a structure of the shower head and a connection of the body, the movable massage set, and the cover, thus reducing fabrication cost.

### BRIEF DESCRIPTION OF THE DRAWINGS

FIG. 1 is a perspective view showing the assembly of a shower head assembly according to a preferred embedment of the present invention.

FIG. 2 is another perspective view showing the assembly of the shower head assembly according to the preferred embedment of the present invention.

FIG. 3 is a perspective view showing the exploded components of the shower head assembly according to the preferred embedment of the present invention.

FIG. 4 is another perspective view showing the exploded components of the shower head assembly according to the preferred embedment of the present invention.

FIG. 5 is a perspective view showing the operation of the shower head assembly according to the preferred embedment of the present invention.

FIG. 6 is another perspective view showing the operation of the shower head assembly according to the preferred embedment of the present invention.

FIG. 7 is a cross sectional view showing the operation of the shower head assembly according to the preferred embedment of the present invention.

FIG. 8 is another perspective view showing the operation of the shower head assembly according to the preferred embedment of the present invention.

### DETAILED DESCRIPTION OF THE PREFERRED EMBODIMENTS

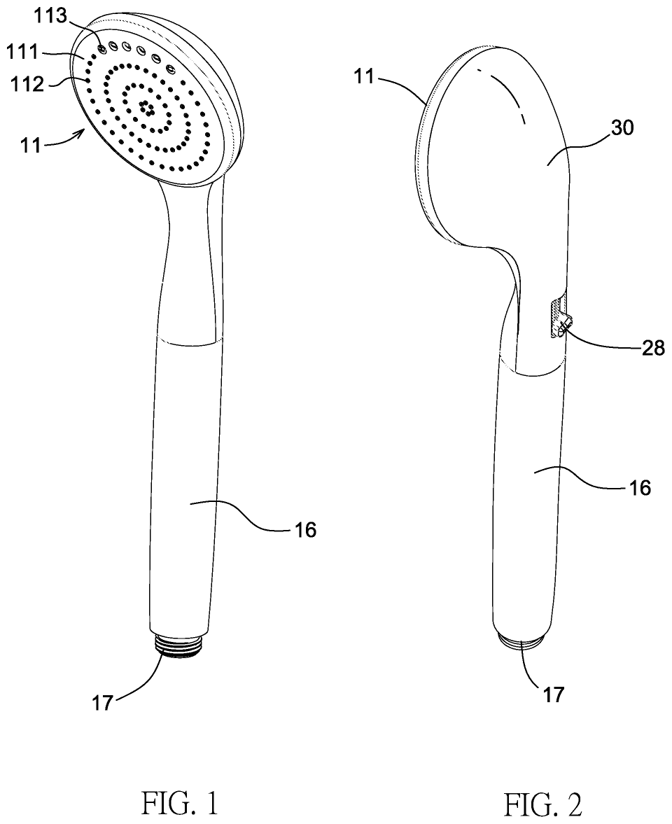

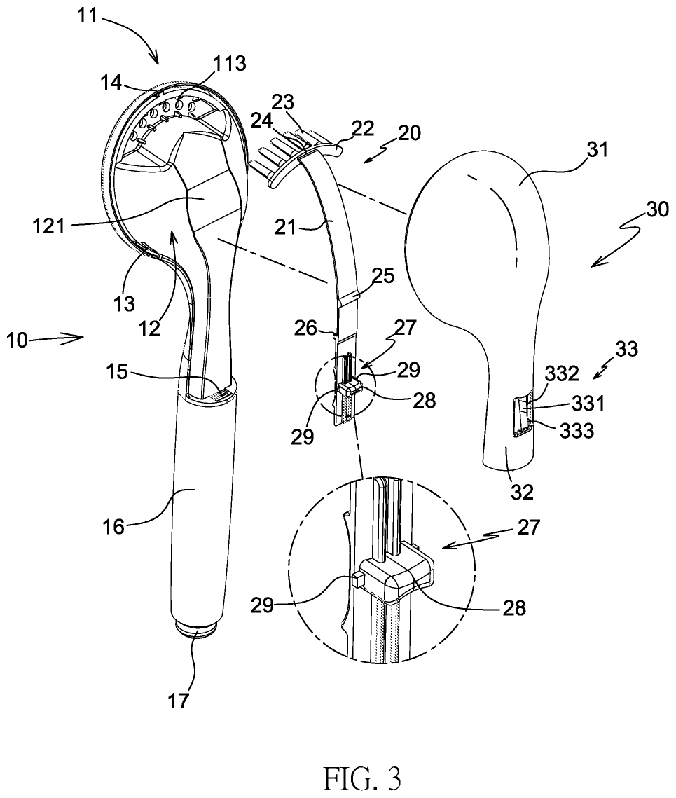

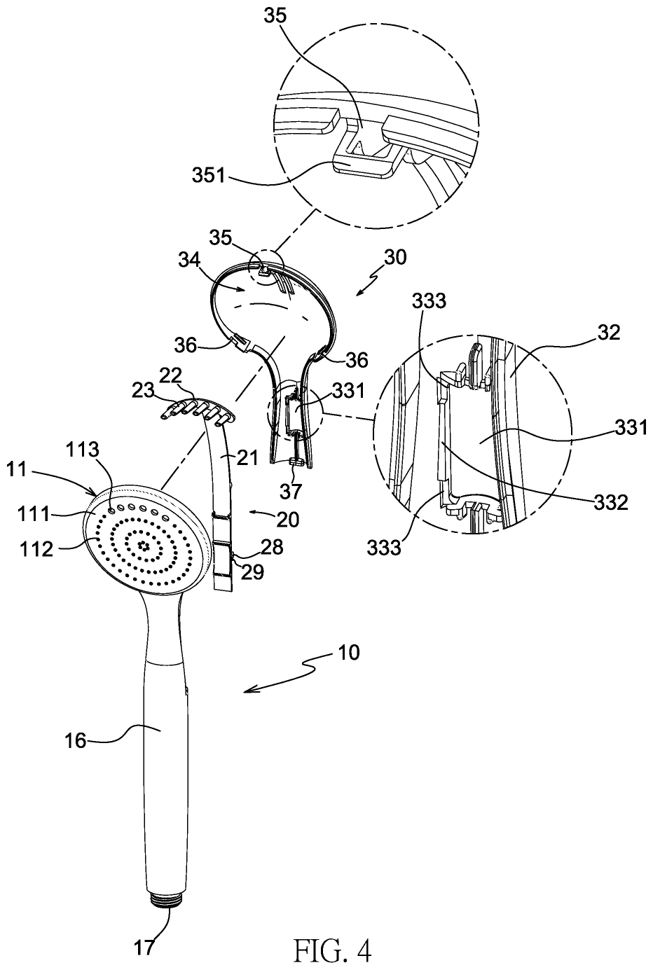

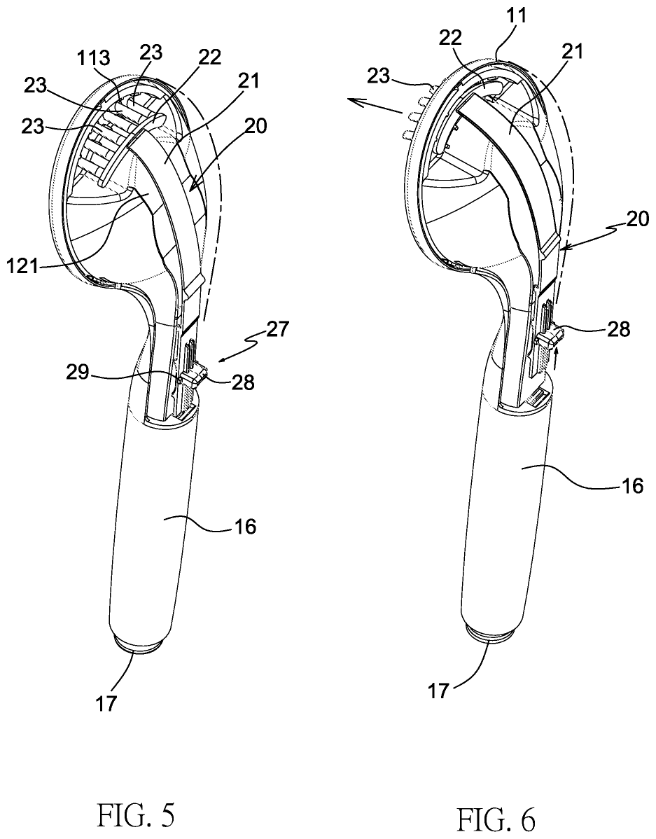

With reference to FIGS. 1-8, a shower head assembly according to a preferred embodiment of the present invention comprises:
a body 10 including a shower head 11 and a handle 16, the handle 16 having an inlet segment 17 formed on a free end of the handle 16, a conduit S1 defined in the shower head 11 opposite to the inlet segment 17, an water supply face 111 formed on an front face 34 of the shower head 11, an external fence 12 formed on a back face of the shower head 11, wherein the water supply face 111 has multiple spray nozzles 112 arranged thereon and communicating with the conduit S1, multiple receiving orifices 113 defined on multiple predetermined positions of the water supply face 111 and communicating with the external fence 12, and the external fence 12 has a slide face 121, a first coupling portion 14 formed on a top of the external fence 12, two opposite second coupling portions 13 formed on two predetermined positions of the external fence 12, and the handle 16 has a positioning portion 15 formed thereon opposite to the external fence 12;
a cover 60 including a head portion 31 and a gripping portion 32, the head portion 31 has a connection face 34, wherein the gripping portion 32 has a fixing protrusion 37 extending from a bottom thereof and corresponding to the positioning portion 15 of the body 10 so that the fixing protrusion 37 is engaged with the positioning portion 15, the connection face 34 has a first retainer 35 corresponding to the first coupling portion 14 of the body 10, and the cover 30 has two second retainers 36 corresponding to the two opposite second coupling portions 13 of the body 10, such that the first retainer 35 is engaged with the first coupling portion 14, the two second retainers 36 are engaged with the two opposite second coupling portions 13 of the body 10, and a slidable channel S2 is defined between the cover 30 and the slide face 121 of the external fence 12 of the body 10, wherein each of the conduit S1 and the slidable channel S2 are an independent space, the gripping portion 32 has a control zone 33 defined on a predetermined position thereof, and the control zone 33 has a slot 331, two moving sections 332 defined on two side walls of the slot 331, and four recesses 333 formed on two ends of the two moving sections 332; and
a movable massage set 20 received in the slidable channel S2 between the body 10 and the cover 30, the movable massage set 20 including a flexible portion 21 made of flexible material and is elongated, the flexible portion 21 having a connection element 22 formed on an first end of the flexible portion 21, multiple defining extensions 23 extending from the connection element 22 and movably extending out of or retracting into the multiple receiving orifices 113 of the body 10, and the connection element 22 is fixed with the external fence 12, wherein the flexible portion 21 has a first abutting section 25 formed on a predetermined position of a first face thereof, a second abutting section 26 formed on a predetermined position of a second face of the flexible portion 21, such that the second abutting section 26 and the first abutting section 25 slidably contact with the slide face 121 of the body 10 and the connection face 34 of the cover 30 so as to reduce a friction coefficient of a movement of the flexible portion 21. Furthermore, the movable massage set 20 includes a control unit 27 arranged on a second end thereof and corresponding to the control zone 33 of the cover 30, wherein the control unit 27 has an actuation projection 28 and two sliding bosses 29 located on two sides of the actuation projection 28, such that the actuation projection 28 is moved back and forth in the slot 331 of the cover 30, the movable massage set 20 are moved to extend out of or retract into the multiple receiving orifices 113 of the body 10, and the two sliding bosses 29 are slid on the two moving sections 332 of the cover 30 and are limited in the four recesses 333.

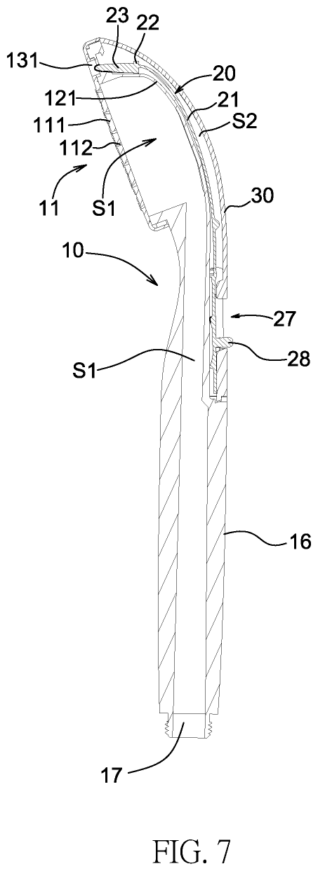

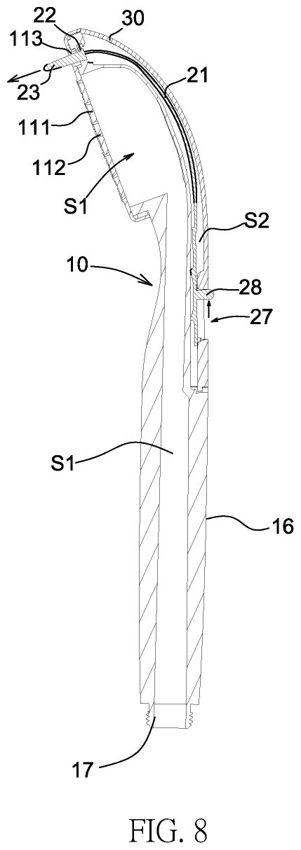

Referring to FIGS. 7-8, in operation, the actuation projection 28 of the movable massage set 20 is moved to drive the multiple defining extensions 23 to extend out of or retract into the multiple receiving orifices 113 of the water supply face 111 of the body 10.

Preferably, the flexible portion 21 of the movable massage set 20 is made of polypropylene (PP) or polyethylene (PE).

Preferably, the movable massage set 20 is one-piece formed.

Preferably, the connection element 22 of the movable massage set 20 includes a stepped shoulder 24 formed thereon, and the cover 30 includes an engagement portion 351 extending from the first retainer 35 of the cover 30 and corresponding to the stepped shoulder 24 so that the multiple defining extensions 23 extend out of the multiple receiving orifices 113 of the body 10, and the stepped shoulder 24 is engaged with the engagement portion 351.

Accordingly, the actuation projection 28 of the movable massage set 20 is moved to drive the multiple defining extensions 23 to extend out of or retract into the multiple receiving orifices 113 of the water supply face 111 of the body 10. After the multiple defining extensions 23 extend out of the multiple receiving orifices 113 of the water supply face 111 of the body 10, the multiple defining extensions 23 massage a user's body. After the multiple defining extensions 23 retract into the multiple receiving orifices 113, the multiple defining extensions 23 are not broken when dropping the shower head on a ground. Furthermore, the movable massage set 20 of the body 10 is slid in the slidable channel S2 and does not interfere a water supply in the conduit S 1, thus flowing water inside the shower head assembly smoothly. Preferably, the shower head assembly comprises the body 10, the movable massage set 20, and the cover 30 merely to simplify a structure of the shower head and a connection of the body 10, the movable massage set 20, and the cover 30, thus reducing fabrication cost.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A shower head assembly comprising:
a body including a shower head and a handle, the handle having an inlet segment formed on a free end of the handle, a conduit defined in the shower head opposite to the inlet segment, an water supply face formed on an front face of the shower head, an external fence formed on a back face of the shower head, wherein the water supply face has multiple spray nozzles arranged thereon and communicating with the conduit, and multiple receiving orifices defined on multiple predetermined positions of the water supply face and communicating with the external fence, wherein the external fence has a slide face, a first coupling portion formed on a top of the external fence, two opposite second coupling portions formed on two predetermined positions of the external fence, and the handle has a positioning portion formed thereon opposite to the external fence;
a cover including a head portion and a gripping portion, the head portion has a connection face, wherein the gripping portion has a fixing protrusion extending from a bottom thereof and corresponding to the positioning portion of the body so that the fixing protrusion is engaged with the positioning portion, the connection face has a first retainer corresponding to the first coupling portion of the body, and the cover has two second retainers corresponding to the two opposite second coupling portions of the body, such that the first retainer is engaged with the first coupling portion, the two second retainers are engaged with the two opposite second coupling portions of the body, and a slidable channel is defined between the cover and the slide face of the external fence of the body, wherein each of the conduit and the slidable channel are an independent space, the gripping portion has a control zone defined on a predetermined position thereof, and the control zone has a slot, two moving sections defined on two side walls of the slot, and four recesses formed on two ends of the two moving sections; and
a movable massage set received in the slidable channel between the body and the cover, the movable massage set including a flexible portion made of flexible material and is elongated, the flexible portion having a connection element formed on an first end of the flexible portion, multiple defining extensions extending from the connection element and movably extending out of or retracting into the multiple receiving orifices of the body, and the connection element is fixed with the external fence, wherein the flexible portion has a first abutting section formed on a predetermined position of a first face thereof, a second abutting section formed on a predetermined position of a second face of the flexible portion, such that the second abutting section and the first abutting section slidably contact with the slide face of the body and the connection face of the cover so as to reduce a friction coefficient of a movement of the flexible portion, and the movable massage set includes a control unit arranged on a second end thereof and corresponding to the control zone of the cover, wherein the control unit has an actuation projection and two sliding bosses located on two sides of the actuation projection, such that the actuation projection is moved back and forth in the slot of the cover, the movable massage set are moved to extend out of or retract into the multiple receiving orifices of the body, and the two sliding bosses are slid on the two moving sections of the cover and are limited in the four recesses.

2. The shower head assembly as claimed in claim 1, wherein the flexible portion of the movable massage set is made of polypropylene (PP) or polyethylene (PE).

3. The shower head assembly as claimed in claim 1, wherein the movable massage set is one-piece formed.

4. The shower head assembly as claimed in claim 1, wherein the connection element of the movable massage set includes a stepped shoulder formed thereon, and the cover includes an engagement portion extending from the first retainer of the cover and corresponding to the stepped shoulder so that the multiple defining extensions extend out of the multiple receiving orifices of the body, and the stepped shoulder is engaged with the engagement portion.
